(19) United States
(12) Patent Application Publication
(10) Pub. No.: US 2004/0022996 A1
(43) Pub. Date: Feb. 5, 2004

(54) Dyeing of cationic dyeable bi-constituent fiber with anionic or acid dyes

(76) Inventor: William G. Jenkins, Lexington, VA (US)

Correspondence Address: NIXON & VANDERHYE P.C., 8th Floor, 1100 North Glebe Road, Arlington, VA, 22201, US

(21) Appl. No.: 10/210,210

(22) Filed: Aug. 2, 2002

(51) Int. Cl. D02G 3/00; B32B 33/00

(52) U.S. Cl. 428/97; 428/373

(57) ABSTRACT

Bi-constituent fibers having a cationic dyeable nylon, usually Type 6 nylon adequately sulfonated, as the major component with an intimate melt blend of a minor amount of a polyester are dyed with an anionic dye to improve lightfastness, ozone resistance and to provide resistance to acid-type stains. The fibers may be tufted into carpets that are resistant to acid-type stains. Both components of the bi-constituent fiber may come from recycled sources so that 100% of the fiber, excluding processing additives, is based on post consumer recycled polymer.

This invention relates to dyeing and printing cationic dyeable bi-constituent fibers with anionic dyes to improve the stain resistance, lightfastness and ozone resistance of nylon, especially nylon carpet.

### BACKGROUND AND SUMMARY OF THE INVENTION

Stain resistant nylon carpets enjoy significant market acceptance. Stain resistance is typically imparted to nylon by treating the fiber as a solid filament or in a carpet form by the application of a chemical finish as described in U.S. Pat. Nos. 4,501,591; 4,592,940; and 4,839,212 to Monsanto.

Nylon carpet fiber is generally classified as to type, depending upon its receptivity to acid dyes and basic or cationic dyes. Cationic dyeable nylons contain within the polymer structure sufficient SO₃H groups or COOH groups (which groups are receptive to cationic or basic dyes) to render the nylon fiber dyeable with cationic dyes. Acid dyeable nylons are essentially conventional nylons, such as polyhexamethylene adipamide and polycaprolactam. Acid dyeable nylons vary as to type and are characterized as being weakly dyed with acid dyes, average dyed with acid dyes, or deeply dyed with acid dyes.

Cationic dyeable nylons generally exhibit inherent stain resistant properties, especially to acid-type stains, as compared to other nylon types used for carpet. Cationic dyeable nylons are dyeable with selected cationic dyes, but suffer from poorer lightfastness, especially in light shades, than do comparable shades dyed on acid dyeable nylon using monosulfonated or premetalized acid dyes. This has resulted in the under-utilization of cationic dyeable nylon as a carpet fiber. The fiber's inherently useful properties, including resistance to acid-type stains, which otherwise make it attractive as a carpet fiber previously have not been fully realized.

Bi-constituent fibers are prepared from a cationic dyeable nylon, usually Type 6 nylon properly sulfonated, as the major component in an intimate melt blend with a minor amount of a polyester. Both components of the blend may come from recycled sources so that 100% of the fiber, excluding processing additives, is based on post consumer recycled polymers.

The advantages of employing the inherent acid type stain resistance of cationic dyeable nylon fibers, particularly when used in carpets and floor coverings, and dyed to the appropriate shade with anionic dyes at pH of about 2.0 to about 6.5 are described in my earlier patents such as U.S. Pat. Nos. 5,085,667; 5,199,958; 5,350,426; 5,354,342; 5,466,527; 5,571,290; 5,912,409 and 6,013,111, the disclosures of which are hereby incorporated by reference. In addition to these advantages of stain resistance, lightfastness and range of stylings, the bi-constituent fibers dyed and/or printed by the process of the present invention provide a fiber that is based almost entirely on 100% recycled products. Acid or anionic dyeing this fiber enhances the color styling choices for the resulting carpet or upholstery items. Blocking any remaining positive dye sites with the anionic or acid dyes further enhances the acid-stain resistant property in bi-constituent fibers based upon sulfonated nylon mixed with polyester.

By dyeing the fiber with anionic dyes in different color effects, such as solid, short-space print, or long-space print in combinations with each other as yarns and separately, the resulting carpet is highly colored and patterned which would not be possible if the fiber was only colored with pigments in solid shades at extrusion.

The resulting yarn can be further enhanced to prevent color destruction with bleaching agents, such as by sodium hypochlorite sold under the name of Clorox®, by aftertreating the yarn with “Cibatex” CL.

Bi-constituent fibers used in the present invention, sometimes referred to as conjugate fibers, can be produced by mixing pellets or particles of polypropylene (PP) as a major component with either nylon or polyester (PET) chips and feeding the mixture to a melting device such as a barrier-distributive mixing screw in a hot melt extruder. The resulting homogeneous mixture is pumped to a spinneret having a multiplicity of capillary holes. The fibers so produced have in-situ fibrils of nylon or polyester formed parallel to the axis of each polypropylene filament and are characterized by continuous and unidirectional nylon or polyester fibers formed within the thermoplastic polypropylene matrix. The process joins or couples together the polymers to produce a conjugate fiber. These fibers are described in a series of patents to William C. Mallonee including U.S. Pat. Nos. 5,811,040; 5,620,797; 5,597,650 and 5,587,118, the disclosures of which are hereby incorporated by reference.

Bi-constituent fibers offer a significant cost advantage over pure nylon carpet face yarn and enable the use of significant amounts of post-consumer (recycle) polyester and/or nylon. Polypropylene by itself is difficult to dye; however mixtures of polypropylene/nylon are convenient to dye and mixtures of polypropylene/polyester are somewhat less convenient.

The preferred bi-constituent fibers for the process of the present invention are made of nylon, such as nylon 6, as the major component, e.g. 55 to 95% by weight, with lesser proportions of polyester, e.g. 45 to 5% by weight, as the minor component. Bi-constituent nylon/PET fibers may be made from substantially or entirely post consumer recycled polymers. Sulfonation of the bi-constituent fiber gives a permanent resistance to acid type or anionic staining materials in carpet or upholstery form while maintaining its ability to be dyed with anionic dyes in yarn form. Highly colored and patterned carpets are prepared by dyeing the bi-constituent fibers with different color effects, such as solid, short-space print, long-space print or similar techniques which results in highly colored and patterned carpet styles. These effects would not be possible if the bi-constituent fiber is only colored with pigments (solution dyed) in solid shades at extrusion.

Preferred bi-constituent fibers used in the invention are an intimate melt blend of cationic dyeable (sulfonated) Type 6 nylon and a polyester. The bi-constituent fiber preferably has an irregular or non-circular cross-section such as a star or trilobal cross-section. In our experience bi-constituent fibers based on a preponderance of polypropylene, such as 70 to 85% blended with cationic dyeable nylon 6, while receptive to anionic dyes and providing a dyeable substrate, unfortunately results in a fiber that lacks sufficient resilience for use in cut pile carpets or similar flooring applications.

The experiments that follow used a fiber which was roughly 70% cationic dyeable, type 6 nylon and 30% polyester (PET). The use of this combination gave much better floor performance than the polypropylene blends. This yarn was dyed into three solid shades, one short-space dyed color and one long-space dyed color. Dye formulas and an explanation of the process follow below.

The following are the dye formulas used to dye the bi-constituent fiber of cationic dyeable nylon and polyester with anionic or acid dyes.

Dye Formulas
Grey Blue Solid
Dye Paste:

| | | |
|---|---|---|
| 0.0062% | Irgalan Red B 220% | (Ciba) |
| 0.234% | Irgalan Blue 3GL 200% | (Ciba) |
| 0.034% | Erionyl Yellow MR 2500/a | (Ciba) |
| 0.4% | Texwet 50 - wetting agent | |
| 0.15% | Sedgekill GGD - Antifoam | |
| 0.15% | Monosodium Phosphate - pH 6.5 | |
| .01-.20% | guar gum thickener to a final | |
| | viscosity of 50 centipoise | |

Dark teal Solid

Chemicals same as above

| | | |
|---|---|---|
| 0.0224% | Irgalan Red B 220% | (Ciba) |
| 0.089% | Erionyl Yellow MR 250% | (Ciba) |
| 0.2425% | Nylanthrene Blue GLF 200% | (Yorkshire) |

Black Solid

Chemicals same as above but pH is 2.0 with phosphoric acid

| | | |
|---|---|---|
| 0.10% | Nylanthrene Orange 3G | (Yorkshire) |
| | Powder 200% | |
| 0.051% | Nylanthrene Red SBL | (Yorkshire) |
| | Concentrate | |
| 4.758% | Ricoamide Black RPL 50% | (Rite Chemical) |
| | Liquid | |

The above colors were padded through a dip/nip padder to 100% moisture pick-up, steamed for 10 minutes (210 degrees saturated steam), washed and dried. Longer or shorter steaming times are possible, the limiting factor being the time necessary to give adequate dye fixation, depending upon depth of shade.

Short Space Dye
Base Color - Light Gold

| | | |
|---|---|---|
| 0.018% | Irgalan Yellow 3RL KWL 250% | (Ciba) |
| 0.25% | Sedgekill GGD Antifoam | |
| 0.2% | MSP pH 6.5 | |
| 0.125% | Sedgemul NID Wetting agent | |
| .05-.5% | guar gum thickener to viscosity 200 cps | |

Print 1 and 6 Design: Green

| | | |
|---|---|---|
| 0.02% | Irgalan Red B KWL 200% | (Ciba) |
| 0.3% | Erionyl Yellow MR 250% | (Ciba) |
| 0.579% | Nylanthrene Blue GLF 200% | (Yorkshire) |

Chemicals same as above

Print 2 and 4 Design: Blue

| | | |
|---|---|---|
| 0.008% | Irgalan Red B KWL 200% | (Ciba) |
| 0.0096% | Irgalan Black RBL 200% | (Ciba) |
| 0.399% | Nylanthrene Blue GLF 200% | (Yorkshire) |

Chemicals same as above

Print 3 and 5 Design: Red

| | | |
|---|---|---|
| 0.286% | Irgalan Red B KWL 200% | (Ciba) |

Chemicals same as above

The base color was padded on a knitted tubular sock followed by engraved roller printing of the different colors per the respective pattern design. After application of the dye, the sock was steamed (210° F. for 10 minutes), washed and dried.

| Long Space Dye: | Gold | Brown | Blue | Green | Teal |
|---|---|---|---|---|---|
| Sedgelev ACB | 0.2 | 0.2 | 0.2 | 0.2 | 0.2 |
| Erionyl Yellow MR 250% | 1.274 | 1.375 | — | 1.397 | — |
| Irgalan Red B KWL 200% | 0.18 | 0.579 | — | 0.132 | — |
| Ricoamide Black RPL 50% Liq. | 0.144 | 0.97 | 2.34 | 10.0 | — |
| Nylanthrene Blue GLF 200% | — | — | 0.63 | — | 0.755 |
| Dianex Red FBE 200% | — | — | 0.6 | — | — |
| Disperite Blue SGBL | — | — | 3.58 | 0.276 | 2.88 |
| Palanil Yellow 3GE 200% | — | — | — | 1.414 | 0.48 |

This color was applied via a “Spectradye” unit which consists of a bank of six sets of color spray nozzles in sequence with each containing a different color, as above. The sequence of spray and length of time of spray is controlled by a computer program that generates the sequence of firing the dye jets as the yarn passes under them. Pattern can be changed by changing the program. Dye is applied in pattern lengths of one to five inches at 15% moisture pick-up. Following color application the yarn passes through a steam chamber, then is coiled onto a Superba belt where it passes through a tunnel-tube set at 250° F for a dwell time of five minutes. The resulting yarns were then tufted into a 1/10 gauge loop graphics carpet at two different densities (at 8.5 stitches per inch, and at 9.6 stitches per inch).

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A process of dyeing bi-constituent fibers comprised of an intimate blend of a cationic dyeable nylon and a polyester comprising dyeing said fibers with an acid dye or a premetalized acid dye at a pH of from about 4.0 to about 6.5 and fixing the dye to the fibers.

2. A process of preparing a stain-resistant, lightfast nylon carpet comprising dyeing bi-constituent fibers comprised of an intimate blend of a cationic dyeable nylon and a polyester with an acid dye or a premetalized acid dye at a pH of from 4.0 to 6.5 to impart the pre-requisite depth of shade to the nylon fibers and heating the dye-laden fibers to fix the dye into the fibers.

3. The process of claim 1 or 2, in which the nylon fibers contain SO₃H and/or COOH groups receptive to cationic or basic dyes in an amount sufficient to render the cationic fiber dyeable with a cationic or basic dye.

4. The process of claim 1 or 2, in which the nylon fibers are dyed at a pH of from about 4.0 to 6.0.

5. The process of claim 1 or 2, in which, subsequent to dye fixation, a fluorocarbon soil repellant is applied to the fibers.

6. The process of claim 1 or 2, in which a premetalized acid dye is used.

7. The process of claim 1 or 2, in which the fibers are overprinted with acid dyes or premetalized dyes to give multiple color effects on the same strand of yarn.

8. Nylon carpet having improved stain resistance composed of bi-constituent fibers comprised of an intimate blend of a cationic dyeable nylon and a polyester dyed at a pH of from about 4.0 to 6.5 with an acid or premetalized acid dye having substantially the same fastness to light as acid dyeable nylon dyed to the corresponding shade.

9. A nylon carpet composed of bi-constituent fibers comprised of an intimate blend of a cationic dyeable nylon and a polyester and dyed at a pH of from about 4.0 to 6.5 to a predetermined depth of shade with an acid dye or a premetalized acid dye, the carpet being resistant to acid stains and exhibiting improved fastness to light as compared to cationic dyeable nylon dyed to a similar depth of shade with a cationic dye.

10. A process of dyeing bi-constituent fibers comprised of an intimate blend of a cationic dyeable nylon and a polyester comprising dyeing said fibers in a dyebath with a premetalized acid dye at a pH of from about 2.0 to about 6.5 and fixing the dye to the fibers.

11. A process of preparing a stain-resistant, lightfast nylon carpet comprising dyeing bi-constituent fibers comprised of an intimate blend of a cationic dyeable nylon and a polyester in a dyebath with a premetalized acid dye at a pH of from about 2.0 to about 6.5 to dye the nylon fibers and heating the dye-laden fibers to fix the dye into the fibers.

12. The process of claim 1 or 2, in which the nylon fibers contain SO₃H and/or COOH groups receptive to cationic or basic dyes in an amount sufficient to render the cationic fibers dyeable with a cationic or basic dye.

13. The process of claim 1 or 2, in which the nylon fibers are overprinted to give multiple color effects on the same strand of yarn.

14. The process of claim 1 or 2, in which, subsequent to dye fixation, a fluorocarbon repellant is applied to the fibers.

15. The process of claim 1 or 2, in which sodium sulfate is also present in the dyebath.

16. A nylon carpet composed of bi-constituent fibers comprised of an intimate blend of a cationic dyeable nylon and a polyester and dyed at a pH of from about 2.0 to about 6.5 with a premetalized acid dye, the carpet being resistant to acid type stains.

17. Stain resistant nylon fibers, suitable for use in producing improved stain resistant carpets, consisting essentially of bi-constituent fibers comprised of an intimate blend of a cationic dyeable nylon and a polyester dyed with a premetalized acid dye at a pH of about 2.0 to about 6.5.

18. A process of preparing a stain resistant, multicolored, cationic dyeable nylon carpet comprising the successive steps of:
(a) space dyeing bi-constituent fibers comprised of an intimate blend of a cationic dyeable nylon and a polyester with an acid dye or a premetalized acid dye at a pH of about 4.0 to 6.5 and fixing the dye to the fibers, the cationic dyeable nylon being intermittently dyed in different colors along the length thereof;
(b) heat setting the space dyed fibers of step (a) by heating them under dry or very low moisture conditions to a temperature of about 160° C. to about 220° C. for a time sufficient to impart dye and stain resistance to the fibers;
(c) tufting the heat set yarns of step (b) and an undyed cationic dyeable nylon into a carpet; and
(d) dyeing the carpet prepared in step (c) with an amount of acid dye or premetalized acid dye sufficient to selectively dye only the previously undyed cationic dyeable nylon and not the previously space dyed, heatset cationic dyeable nylon, to produce a multicolored stain resistant carpet.

19. The process of claim 18, in which a premetalized dye is used in step (a), step (d) or both.

20. The process of claim 18, in which an acid dye is used in step (a), step (d) or both.

21. The process of claim 18, including the additional step of (e) applying a fluorocarbon soil repellant to the carpet.

22. A multicolored nylon textured cut pile carpet constructed entirely of bi-constituent fibers comprised of an intimate blend of a cationic dyeable nylon and a polyester having improved stain resistance, dyed to two or more different shades with an acid or premetalized acid dye, intermixed and tufted with bi-constituent fibers dyed to a background shade with a different shade of acid dye or premetalized acid dye.
